(19) United States
(12) Patent Application Publication
(10) Pub. No.: US 2007/0055793 A1
(43) Pub. Date: Mar. 8, 2007

(54) System of managing peripheral interfaces in IPMI architecture and method thereof

(75) Inventors: Shih-yuan Huang, Keelung City (TW); Fwu-bin Hsu, Taoyuan City (TW)

Correspondence Address: TROXELL LAW OFFICE PLLC, SUITE 1404, 5205 LEESBURG PIKE, FALLS CHURCH, VA, 22041, US

(73) Assignee: WELLSYN Technology, Inc.

(21) Appl. No.: 11/195,712

(22) Filed: Aug. 3, 2005

(51) Int. Cl. G06F 3/00

(52) U.S. Cl. 710/8

(57) ABSTRACT

A system of managing a plurality of peripheral interfaces in an IPMI architecture to communicate with a plurality of peripheral controllers is provided. The system comprises a memory address table, a firmware module for reading the memory address table to acquire an initial address corresponding to the respective peripheral interface and add an offset address to the initial address to generate an information structure, a protocol unit for converting each information structure to comply with a specific device protocol, a memory unit coupled to the memory address table, which is accessible according to the information structure with specific device protocol, to store/acquire a corresponding peripheral controller information, and a driver table coupled to the firmware module, having a plurality of peripheral controller drivers, corresponding to the respective peripheral controllers, each which are accessed by the firmware module in accordance with a specific peripheral controller information. At least one of the peripheral controllers is initialized according to the corresponding peripheral controller driver.

### BACKGROUND OF INVENTION

1. Field of the Invention

The present invention relates to a computer system, more particularly, to a computer system and method for managing different drivers for driving various peripheral controllers under IPMI architecture.

2. Description of the Prior Art

Recently, the overall number of servers is increasing year by year in many companies, especially in multi-nations enterprises. Nevertheless, conventionally, as soon as a remote server, i.e. a server which is not physically located on the acting person's “desk”, is in malfunction, the diagnosis of the remote server is normally accomplished by bringing a skilled person (i.e. a administrator) to the server. That is very inconvenient for management. Nowadays, in order to overcome such defect to easily manage the remote server's health, the Intelligent Platform Management Interface (IPMI) specification regulated by Intel, NEC, Hewlett-Packard, and Dell corporation provides a standard interface to hardware used for monitoring characteristics of the server, such as temperature, voltage, power supplies and fans. IPMI-enable servers monitor and store platform information in a common format which can be accessed by server management software or directly from the server provides. The monitoring and controlling functions of the IPMI are independent of the server's main processor, BIOS, and operating system through the use of a baseboard management controller (BMC). The BMC provides the information behind IPMI and the ability for other agents, such as BIOS, to access the IPMI system. The BMC is also used for communicating with peripheral controllers which assist the operations of the server. However, various peripheral controllers manufactured by the different chipmakers require different drivers to drive. For instance, the sensor features functioning as hardware monitors for monitoring the voltage level or temperature have various type such as LM 85, LM 75, and W83627HF, and are driven by respective driver usually provided by their chipmakers. Traditionally, when installing an operating system and the drivers corresponding to the peripheral controllers in a server, the server manufacturer has to test the server for a long while on the spot until the installation is completed. If the manufacturer replaces the original peripheral controller to another type one, for example, replace the sensor feature from LM 85 to W83627HF, the administrator or the user has to re-install a new driver, which may be not in compatibility with an original BMC. Therefore, the user or the administrator has to spend additional time for testing compatibility of the new installed drivers. That wastes much time and labor cost. As a result, if a BMC in compatibility with various peripheral controllers is developed, it will be convenient for the server manufacturer to shorten the time in either testing compatibility with a new installed driver, or resetting relative parameters for the new installed driver.

### SUMMARY OF INVENTION

It is therefore a primary objective of this invention to provide a computer system, more particularly, to a computer system and method for managing different drivers for driving various peripheral controllers under IPMI architecture.

The present invention discloses a system of managing a plurality of peripheral controllers on an IPMI-enabled server, having a plurality of peripheral controllers mounted thereon. The system includes a storage device and a baseboard management controller. The storage device stores a plurality of derivers and the baseboard management controller communicates with the plurality of peripheral controllers via a part of the drivers chosen from the storage device. In the present invention, the number of the drives stored in the storage device is more than the number of the peripheral controllers mounted on the IPMI-enabled server. The IPMI supplier has confirmed the compatibility between the drives and the peripheral controllers in advance. Meanwhile, the IPMI supplier suggests the proper peripheral controllers.

Briefly summarized, the preferred embodiment of the present invention discloses a system of managing a plurality of peripheral interfaces in an IPMI architecture to communicate with a plurality of peripheral controllers. The system comprises a memory address table, a firmware module for reading the memory address table to acquire an initial address corresponding to the respective peripheral interface and add an offset address to the initial address to generate an information structure, a protocol unit for converting each information structure to comply with a specific device protocol, a memory unit coupled to the memory address table, which is accessible according to the information structure with specific device protocol, to store/acquire a corresponding peripheral controller information, and a driver table coupled to the firmware module, having a plurality of peripheral controller drivers, corresponding to the respective peripheral controllers, each which are accessed by the firmware module in accordance with a specific peripheral controller information. At least one of the peripheral controllers is initialized according to the corresponding peripheral controller driver.

According to the claimed invention, a method of managing a plurality of peripheral interfaces in an IPMI system to communicate with a plurality of peripheral controllers, comprises the steps of:
accessing a memory unit to acquire a peripheral controller information;
storing the peripheral controller information in an information table;
reading a device index corresponding to the peripheral controller information from the information table;
acquiring at least one peripheral controller driver corresponding to the device index from a driver table; and
initializing the peripheral controllers according to the peripheral controller driver to select at least one peripheral controller.

It is an advantage of the present invention that by accessing pre-defined parameters corresponding the peripheral controllers stored in the memory unit, the BMC is able to properly determine the correct driver to drive the peripheral controller as a new peripheral controller is installed to co-work with the BMC, and thus the user will not waste time to set parameters for the driver corresponding to the new peripheral controller or even write a new driver for the peripheral controller.

The disclosed inventions will be described with reference to the accompanying drawings, which show important sample embodiments of the invention and which are incorporated in the specification hereof by reference.

### BRIEF DESCRIPTION OF THE DRAWINGS

FIG. 1 shows a functional block diagram of an IPMI system according to the present invention.

FIG. 2 shows a flowchart of the operation of BMC and the memory unit according to the present invention.

FIG. 3 illustrates an operation relationship between the BMC and the memory unit.

### DETAILED DESCRIPTION OF THE PREFERRED EMBODIMENT

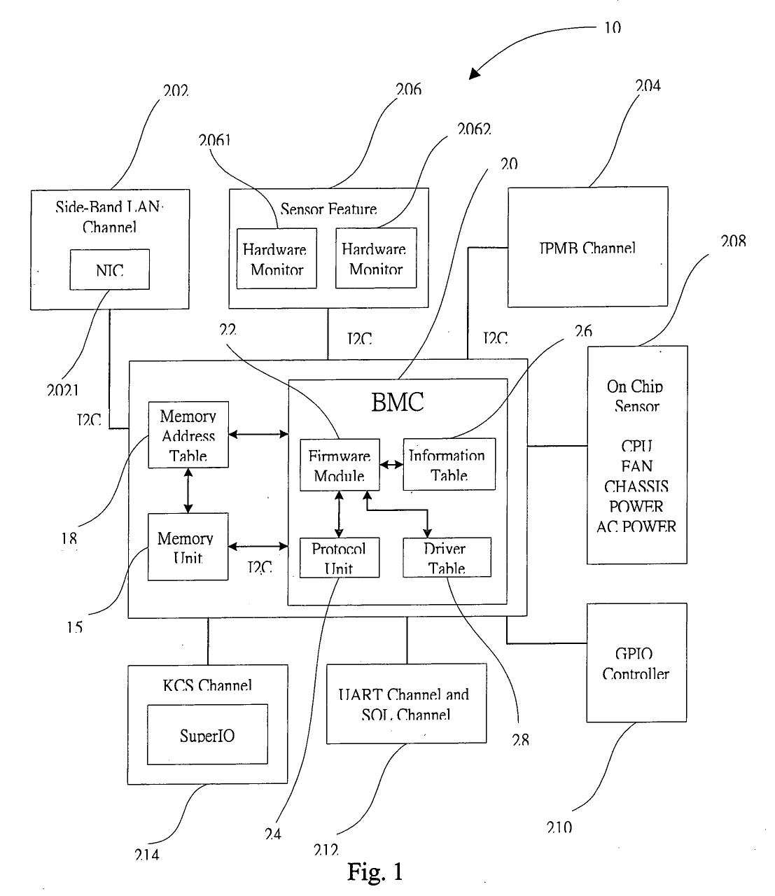

Please refer to FIG. 1, which shows a functional block diagram of an IPMI system according to the present invention. The IPMI system which may be a server 10 is remote-controlled by a remote console (not shown) over a network. The server 10 comprises a baseboard management controller (BMC) 20, and a memory unit 15. Both the BMC 20 and the memory unit 15 can be mounted on a daughter board or integrated into a single chip. The BMC 20 which performs system management functions based on the IPMI specification comprises a firmware module 22, a protocol unit 24, an information table 26 and a driver table 28 stored designated drivers for initializing various peripheral controllers, such as a side-band LAN channel 202, an Intelligent Platform Management Bus (IPMB) channel 204, a sensor feature 206 having a plurality of hardware monitors for monitoring the temperature or voltage of fans and a main board, an on-chip sensor 208, a General Purpose Input/Output (GPIO) controller 210, an Universal Adaptive Receiver/Transmitter (UART) and Serial over LAN (SOL) channel 212 for connecting to interfaces using UART or serial transmission technique, and a keyboard controller style (KCS) 214. The BMC 20 and the peripheral controllers are installed to a printed circuit board configured to be added or removed to the server 10 after manufacture and assembly.

The side-band LAN channel 202 with a network interface card (NIC) 2021 is capable of connecting to Ethernet. The LAN interface specifications define how IPMI messages can be sent to and from the BMC 20 encapsulated in RMCP (Remote Management Control Protocol) packets datagram. The IPMB channel 204 allows add-in peripheral controllers to access the platform management information based on the IPMI specification, even if a CPU (not shown in FIG. 1) of the server 10 is down. The BMC 20 of the preferred embodiment utilizes side-band to communication with the NIC 2021. The BMC 20 provides one I2C bus for LAN channel.

The Intelligent Platform Management Bus (IPMB), an I2C-based serial bus that is routed between major system modules, is used for communication to and between management controllers. Because the IPMB channel 204 are typically distributed on other boards within the server 10, away from the “central” BMC 20, referring to as a satellite controller. This channel is optional.

The server 10 provides two types of sensors, one is on chip sensor 208, and the other is sensor feature 206 having a plurality of I2C sensors. Sensor events can be discrete or threshold-based. The embodiment shown in FIG. 1 shows two hardware monitors while alternate embodiments may include less than two or more than two hardware monitors. Hardware monitors 2061 and 2062 are used to measure such operating characteristics as temperature, voltage, power supplies, fans, or any other appropriate operating parameters that affects performance. For instance, the hardware monitor 2061 may measure temperature levels of the CPU of the server 10, the hardware monitor 2062 may measure cooling fan presence and operation.

The GPIO controller 210 is used for programmable pins to manage user controls for the presence/absence of BMC, disability of CPU, the system power/reset control, and receiving of a liquid crystal display (LCD) panel control signal.

The UART channel and SOL channel 212 provides a serial transmission interface that the IPMI messages can be sent to and form the BMC 20 via a direct serial connection. Serial over LAN (SOL) channel can be used to enable asynchronous serial-based OS and pre-OS communication over a connection to the BMC 20. The BMC 20 supplies one UART channel for this feature. This function is mandatory.

The KCS channel 214 may be implemented with or include a portion of a commercially distributed component such as the SuperIO chip from National Semiconductor. The KCS channel 214 is used for communication between the BMC 20 and System Management Software (SMS) designed to run under the OS of the server 10. And the KCS channel 214 is the only channel for SMS messages. The KCS channel 214 uses Low Pin Count (LPC) protocol. This channel is mandatory.

The driver table 28 includes a plurality of drivers, each for driving respective peripheral controller. The firmware module 22 stored in the BMC 20 is designated to coordinate the operation between the plurality of peripheral controllers and memory unit 15. The memory unit 15 which can be a non-volatile memory, e.g. an electrically erasable programmable read-only memory (EEPROM), stores data including System Event Log (SEL) indicative of a historical log of what has happened in the past with respect to the peripheral controllers, Sensor Data Record (SDR) indicative of parameters associated to the peripheral controllers, to provide status parameters corresponding to the drivers of the peripheral controllers. The SDR is a data record that provides information regarding peripheral controllers such as peripheral controllers type, peripheral controllers location, access information, and information on what types of readings the peripheral controllers provides. For instance, the SDR for sensor feature 206 may records such information as that sensor feature 206 monitors the temperature of CPU of the server 10, the location of the sensor feature 206 within the server 10. So the purpose of the SDR is to define the peripheral controller configuration to the BMC 20. Additionally, The SDR may also include information that identifies the owner of peripheral controller.

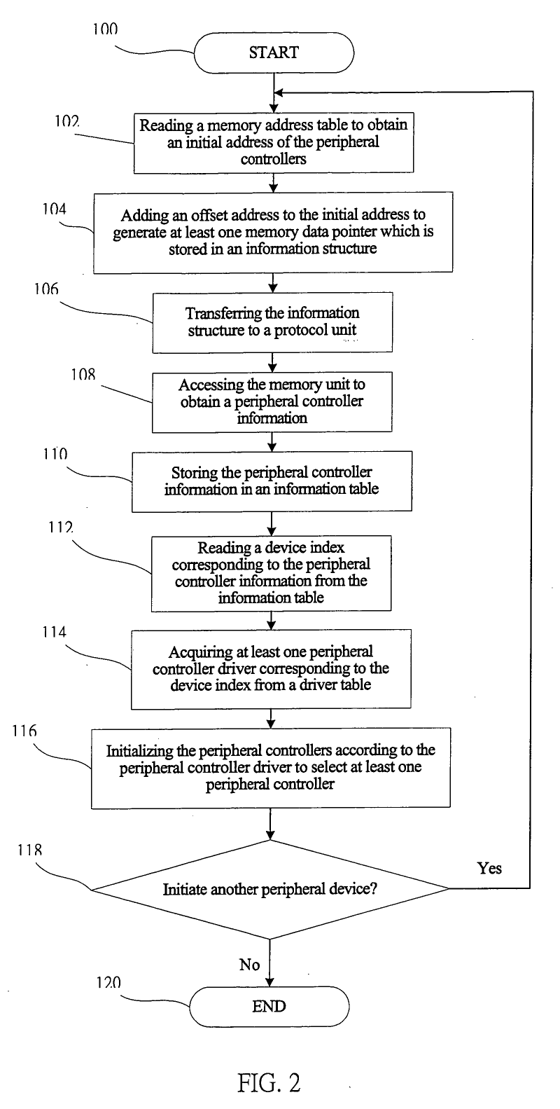

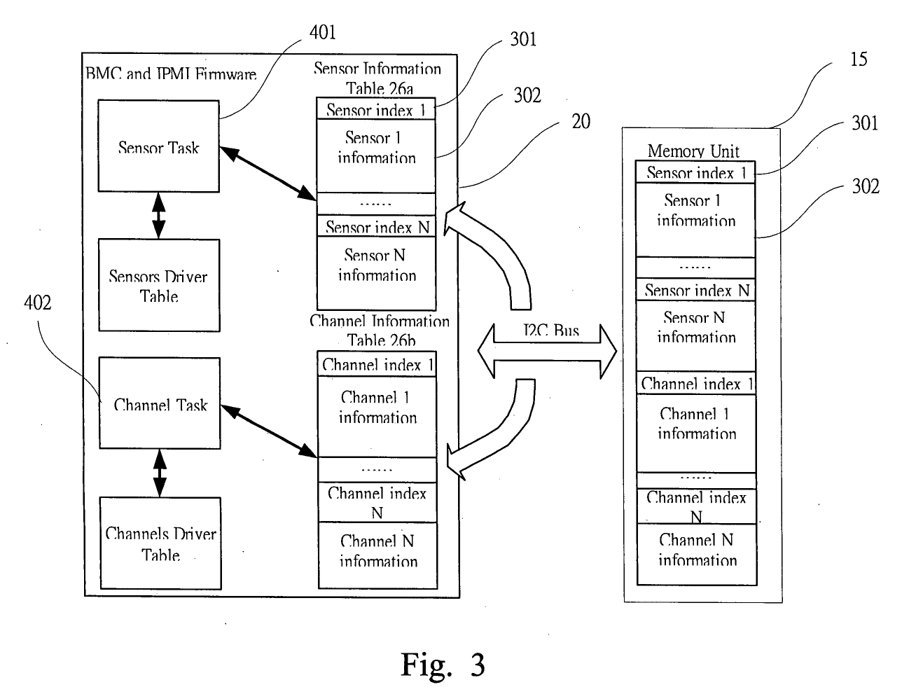

In order to understand the operation between the peripheral controllers and the BMC, please refer to FIG. 2. FIG. 2 shows a flowchart of the operation of BMC 20 and the memory unit 15 according to the present invention. FIG. 3 illustrates an operation relationship between the BMC and the memory unit. Based on the above-mentioned structure of the BMC 20, the method of the operation of the BMC 20 and the memory unit 15, includes the following steps:
Step 100: Start.
Step 102: Reading a memory address table 18 to obtain an initial address of the peripheral controllers.
Step 104: Adding an offset address to the initial address to generate at least one memory data pointer which is stored in an information structure.
Step 106: Transferring the information structure to a protocol unit.
Step 108: Accessing the memory unit to obtain a peripheral controller information.
Step 110: Storing the peripheral controller information in an information table.
Step 112: Reading a device index corresponding to the peripheral controller information from the information table.
Step 114: Acquiring at least one peripheral controller driver corresponding to the device index from a driver table.
Step 116: Initializing the peripheral controllers according to the peripheral controller driver to select at least one peripheral controller.
Step 118: Initiate another peripheral controller? If it is, go to Step 102, if not, go to Step 120.
Step 120: End.

Please refer to FIG. 3 in conjunction to FIGS. 1 and 2. FIG. 3 illustrates an operation relationship between the BMC and the memory unit. As described above, for the same purpose of functionality, various chipmakers produce different peripheral controllers and drivers thereof. Therefore, replacing either peripheral controllers for example, the sensor feature 206, the firmware module 22 of the BMC 20 executes a sensor task 401 and thus reads the memory table 18 to acquire an initial address of the sensor feature 206 (Step 102). Next, the firmware module 22 adds an offset address to the initial address to generate at least one memory data pointer, for example sensor index 1. Such memory data pointer is stored in an information structure (Step 104). The memory data pointer is indicative of an address corresponding to a driver of the sensor feature 206 stored in the memory unit 15. Then, the firmware module 22 transfers the information structure to the protocol unit 24 which can package the information structure to comply with the transmission protocol, e.g. I2C protocol (Step 106). Afterwards, the firmware module 22 accesses the memory unit 15, via the 12C bus, to obtain sensor feature information based on the memory data pointer (Step 108). The firmware module 22 will store the sensor feature information from the memory unit 15 in an information table 26 (Step 110). In FIG. 3, the memory unit 15 stores sensor 1 information, . . . , sensor N information, and channel 1 information, . . . , channel N information, each indicating different sensor or channel parameters. In addition, in this embodiment, the information table 26 is divided into a sensor information table 26a for recording sensor information from the memory unit 15, and a channel information table 26b for recording channel information from the memory unit 15.

It should be noted that sometimes several peripheral controllers are replaced, the firmware module 22 can access the memory table 18 to acquire several initial address corresponding to the peripheral controllers. And, the firmware module 22 will execute the sensor task 400 or the channel task 401 to access various peripheral controller information from the memory unit 15 based on the initial addresses and an corresponding offset address, and will store the peripheral controller information (e.g. the sensor information and the channel information) into an information table 26. Then, the firmware module 22 reads a sensor index 301 of the sensor information, or a channel index of the channel information from the sensor information table 26a, to take out the sensor 1 information. The firmware module 22 can parse the sensor 1 information, i.e. SDR, which defines the peripheral controller configuration to the BMC 20 and identifies the owner of sensor feature (Step 112). The firmware module 22 acquires the sensor feature driver from the driver table 28 based on the sensor feature index 301 (Step 114). Finally, the sensor feature 206 is initialized according to the sensor feature driver (Step 116). If more than one peripheral controller are replaced, the whole procedure repeats until all peripheral controllers are driven by proper drivers. In addition, if no proper driver for desired peripheral controller is available, the BMC 20 will alarm the user.

Furthermore, the BMC 20 provides a hardware/software interface so that a plurality of driver code may be written by means of software interface. The BMC 20 can support the Intelligent Platform Management Interface (IPMI) specification. The drivers can be stored in a RAM of the BMC 20 or in the memory unit 15.

In contrast to prior art, the present invention provides a BMC storing various drivers for initialing and driving different peripheral controllers. If a user wants to replace part peripheral controllers in the server, the firmware module of the BMC will read the it is the drivers components in cooperation with a memory unit storing system of managing a plurality of peripheral interfaces in an IPMI architecture to communicate with a plurality of peripheral controllers.

The present invention has been described with reference to certain preferred and alternative embodiments which are intended to be exemplary only and not limiting to the full scope of the present invention as set forth in the appended claims.

What is claimed is:

1. A system of managing a plurality of peripheral interfaces in an IPMI architecture to communicate with a plurality of peripheral controllers, the system comprising:
a memory address table;
a firmware module for reading the memory address table to acquire an initial address corresponding to the respective peripheral interface and add an offset address to the initial address to generate an information structure;
a protocol unit for converting each information structure to a device protocol comply with the IPMI protocol;
a memory unit coupled to the memory address table, which is accessible according to the information structure with the device protocol, to store/acquire a corresponding peripheral controller information; and
a driver table coupled to the firmware module, having a plurality of peripheral controller drivers, corresponding to the respective peripheral controllers, each of which being accessed by the firmware module in accordance with a peripheral controller information; whereby at least one of the peripheral controllers is initialized according to the corresponding peripheral controller driver.

2. The system of claim 1, wherein the memory unit is an EEPROM.

3. The system of claim 1, wherein the peripheral controllers comprises sensors.

4. The system of claim 1, wherein the peripheral controllers comprises channels.

5. The system of claim 1, wherein the information structure comprises memory data pointer.

6. The system of claim 1, further comprising an information table coupled to the firmware module, having several peripheral controller information, corresponding to the peripheral interfaces, which is accessible by the firmware module, wherein the peripheral controller information is represented as the information structure.

7. The system of claim 1 being a baseboard management controller module.

8. A method of managing a plurality of peripheral interfaces in an IPMI system to communicate with a plurality of peripheral controllers, the method comprising:
accessing a memory unit to acquire a peripheral controller information;
storing the peripheral controller information in an information table;
reading a device index corresponding to the peripheral controller information from the information table;
acquiring at least one peripheral controller driver corresponding to the device index from a driver table; and
initializing the peripheral controllers according to the peripheral controller driver to select at least one peripheral controller.

9. The method of claim 8, before the step of accessing the memory unit, further comprising a step of reading a memory address table to acquire an initial address of the peripheral interfaces.

10. The method of claim 9, after the step of reading a memory address table, further comprising a step of adding an offset address to the initial address to generate at least one memory data pointer which is stored in an information structure.

11. The method of claim 10, after the step of adding an offset address to the initial address, further comprising a step of transferring the information structure to a protocol unit.

12. A system of managing a plurality of peripheral controllers on an IPMI-enabled server, the system comprising:
a storage device for storing a plurality of drivers for driving the plurality of peripheral controllers; and
a baseboard management controller for communicating with the plurality of peripheral controllers through drivers chosen from the plurality of drivers stored in the storage device.

13. The system of claim 12 further comprising:
a memory address table;
a firmware module for reading the memory address table to acquire an initial address corresponding to the respective peripheral interface and add an offset address to the initial address to generate an information structure;
a protocol unit for converting each information structure to a device protocol comply with IPMI protocol; and
a memory unit coupled to the memory address table, which is accessible according to the information structure with device protocol, to store/acquire a corresponding peripheral controller information,
wherein the firmware module chooses the corresponding drivers from the plurality of drivers stored in the storage device to drive the plurality of peripheral controllers based on the peripheral controller information.

14. The system of claim 13, wherein the memory unit is an EEPROM.

15. The system of claim 13, wherein the peripheral controllers comprises sensors.

16. The system of claim 13, wherein the peripheral controllers comprises channels.
